(19) United States
(12) Patent Application Publication
(10) Pub. No.: US 2011/0055341 A1
(43) Pub. Date: Mar. 3, 2011

(54) CONTENT PROVIDING APPARATUS AND CONTENT PROCESSING METHOD

(75) Inventor: Masahiro Handa, Tokyo (JP)

(73) Assignee: CANON KABUSHIKI KAISHA, Tokyo (JP)

(21) Appl. No.: 12/857,376

(22) Filed: Aug. 16, 2010

(30) Foreign Application Priority Data
Sep. 1, 2009 (JP) 2009-201478

(51) Int. Cl. G06F 15/16

(52) U.S. Cl. 709/206; 709/219

(57) ABSTRACT

A device search unit of a digital camera acquires type information of a device on a network. An attribute information determination unit, based on type information acquired by the device search unit, determines parameters of the content to be provided to the device corresponding to the type information. The content providing unit provides the content processed based on the determined parameters in response to a request from the device having parameters determined by an attribute information determination unit.

### BACKGROUND OF THE INVENTION

1. Field of the Invention

The present invention relates to a content providing apparatus for providing contents in accordance with a request from a device on a network.

2. Description of the Related Art

With the advent of digital household electrical appliances such as a personal computer (PC), a television (TV), a digital camera, and a printer connectable to a network, a plurality of devices have become capable of exchanging multimedia data through the network even in houses. As a procedure for communicating between communication devices intended for such home use, communication standards such as Universal Plug and Play (UPnP), Digital Living Network Alliance (DLNA) are laid down. A user downloads contents from an apparatus for holding contents such as a content server or a digital recorder, into an apparatus for playing back contents such as a TV or a speaker. By downloading multimedia contents such as photos, images, audios, and videos, the user can view them.

However, a variety of content attributes (e.g., screen size and compression format) exist even in the same type of multimedia content (e.g., an image). In addition, suitable content attributes vary depending on playback apparatuses.

Japanese Patent Application Laid-Open No. 2007-215202 discusses a method for providing contents suitable for a playback apparatus from an apparatus for providing contents. Japanese Patent Application Laid-Open No. 2007-215202 discusses that if a character code called “Mobile” is included in a content acquisition request from the playback apparatus, a content providing apparatus provides contents with coarse image quality but high compression ratio. On the other hand, Japanese Patent Application Laid-Open No. 2007-215202 discusses that if the character code called “Mobile” is not included in the content acquisition request from the playback apparatus, the content providing apparatus provides contents with good image quality but low compression ratio.

However, there is a possibility that it might take a time from receiving a request for the content until starting to provide the content of the content attributes corresponding to the type of a device which has requested the content.

If an attempt is made to judge more detailed type of the device, than the type of the device to be judged according to, for example, presence or absence of the character code of “Mobile”, there is a possibility that it might take a time until starting to provide the content.

Moreover, for example, if exchanges of information are performed a plurality of times with the device which has requested the content in order to judge detailed type of the device which has requested the content, there is also a possibility that it might take a time until starting to provide the content.

### SUMMARY OF THE INVENTION

The present invention is directed to a content providing apparatus that can shorten a time required from receiving a request for the content until starting to provide the content of the content attributes corresponding to the type of the device that has requested the content.

According to an aspect of the present invention, a content providing apparatus that provides a content in accordance with a request from a device on a network includes an acquisition unit configured to acquire type information of the device on the network, a determination unit configured to determine parameters of content to be provided to the device corresponding to the type information, based on the type information acquired by the acquisition unit, a reception unit configured to receive a request from the device on the network, and a providing unit configured to provide to the device that transmitted the request, content processed based on parameters determined by the determination unit, in response to the request from the device on the network having parameters determined by the determination unit based on the type information acquired by the acquisition unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a network configuration example of an exemplary embodiment.

FIG. 2 is an internal configuration example of a digital camera.

FIG. 3 is a flowchart illustrating processing of the digital camera.

FIG. 4 is a sequence diagram of processing for performing search for a content outputting apparatus.

FIG. 5 illustrates an example of a response message of the content outputting apparatus to an M-Search.

FIG. 6 illustrates an example of a device description.

FIG. 7 illustrates an example of a device information table.

FIG. 8 illustrates an example of an attribute table.

FIG. 9 is a flowchart illustrating registration of a discovered content outputting apparatus on a device information table.

### DESCRIPTION OF THE EMBODIMENTS

Various exemplary embodiments, features, and aspects of the invention will be described in detail below with reference to the drawings.

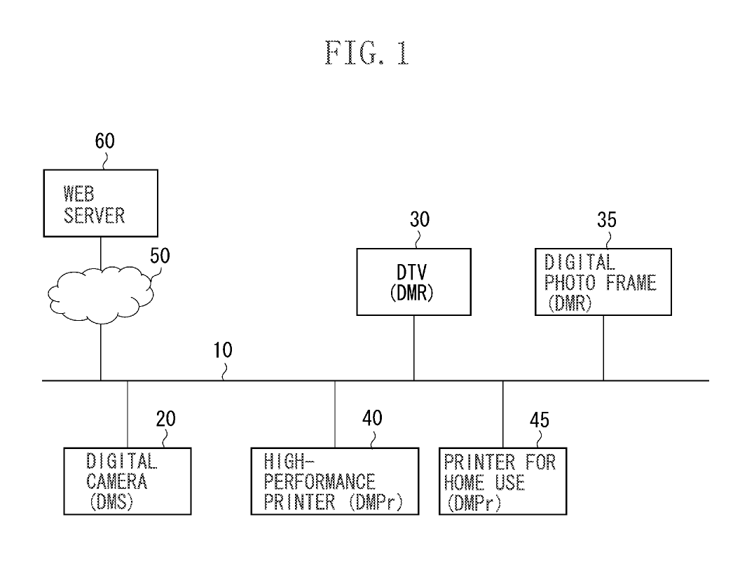

FIG. 1 illustrates a general configuration of a content providing system according to the present exemplary embodiment. In FIG. 1, a digital camera 20 has a server function of content providing. More specifically, the digital camera 20 is a content providing apparatus that provides contents in accordance with a request (content acquisition request) from a device on a network (on a network 10).

The digital camera 20 discovers a content outputting apparatus having a function of outputting (playing back) contents. Then, the digital camera 20 acquires a MAC address of a discovered content outputting apparatus, and attribute information (content attributes) of the content suitable for the type of the content outputting apparatus, and stores them in association with each other. Then, the digital camera 20 provides the content suitable for the content outputting apparatus that has requested the content, based on the MAC address of transmission source of the content acquisition request.

FIG. 1 illustrates a general configuration of the content providing system according to the first exemplary embodiment.

As described above, the digital camera 20 is a content providing apparatus that provides contents in association with a content acquisition request from the device on the network 10. The digital camera 20 can distribute contents using Hyper Text Transfer Protocol (HTTP).

The network 10 is a network for transferring data between connected apparatuses. The network 10 is, for example, an Ethernet (registered trademark) or a wireless local area network (LAN). Further, a digital TV (hereinafter, a DTV 30) for displaying contents, a digital photo frame 35 (hereinafter, a DPF 35), a high-performance printer 40 for printing contents, a home printer 45 are connected to the network 10.

In the present exemplary embodiment, the DTV 30, the DPF 35, the high-performance printer 40, and the home printer 45 are devices (content outputting apparatuses) for outputting contents. The DTV 30 according to the present exemplary embodiment is capable of displaying higher-quality contents than those of the DPF 35. Further, the high-performance printer 40 according to the present exemplary embodiment can print higher-quality contents than those of the home printer 45. Quality of contents which respective devices output will be described below.

An Web server 60, connected to the Internet 50, stores device types of content outputting apparatuses and content attributes in association with each other. Then, the Web server 60 notifies the digital camera 20 of the device type corresponding to the content attributes included in an inquiry from the digital camera 20. The Web server 60 may exist on the network 10. Also, the Internet 50 may be an external network other than the Internet.

The digital camera 20 (content providing apparatus) is capable of advertising/detecting devices or services, and providing contents using framework of UPnP and DLNA. The above-described content outputting apparatus is capable of advertising/detecting devices or service, and requesting contents using framework of the UPnP and DLNA. More specifically, the following protocols to be used in the UPnP and DLNA are installed on the digital camera 20 and each content outputting apparatus.
Simple Service Discovery Protocol (SSDP) to be used for detection of devices or services;
Simple Object Access Protocol (SOAP) to be used for exchange of extensible markup language (XML) data;
General Event Notification Architecture (GENA) to be used for various notifications between devices;

The digital camera 20 (content providing apparatus) has a function of Digital Media Server (DMS). Further, the DTV 30 and the DPF 35 have a function of Digital Media Renderer (DMR), and the high-performance printer 40 and the home printer 45 have a function of Digital Media Printer (DMPr).

In the present exemplary embodiment, respective devices have a function of device class of the DLNA although other frameworks and other protocols having the similar functions may be used.

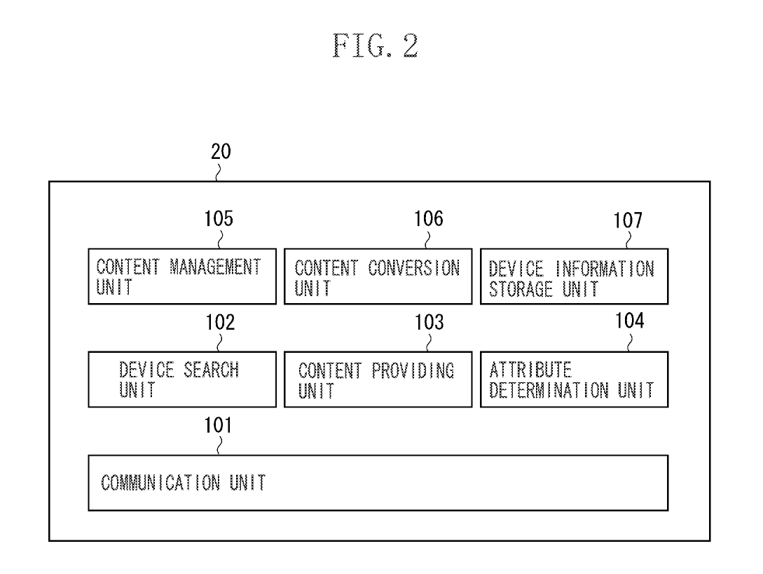

FIG. 2 illustrates an internal configuration of the digital camera 20. A communication unit 101 transmits and receives messages through the network 10. A device search unit 102 searches a content outputting apparatus to be connected to the network 10 using the M-Search of the SSDP. Then, the device search unit 102 acquires a device type (type information), mode information, and a MAC address of the content outputting apparatus discovered by a response of the M-Search.

The device type in the present exemplary embodiment, in a case of a digital TV, for example, is composed of a product name (e.g., CanoDTV) of the device, a screen size (e.g., 36 inch), and a version (e.g., v1.0). The device type of the printer, for example, is composed of a product name (CanoDMPr), a product category (e.g., Pro), and a version (e.g., v1.0) of the device. The details of a method for acquiring the device type and the mode information will be described below. In the present exemplary embodiment, an example of determining the content attributes composed of the device type and the mode information will be described, but may also be determined from the type information such as a model number, and a source of manufacture information of the device. The device search unit 102 notifies the attribute determination unit 104 of the device type, the mode information, and the MAC address.

The attribute determination unit 104 determines content attributes corresponding to the device type and the mode information acquired by the device search unit 102. More specifically, the attribute determination unit 104 determines parameters (content attributes) of the content to be provided to the device corresponding to the device type, based on the device type acquired by the device search unit 102. The content attributes in the present exemplary embodiment includes a compression format, a number of pixels (resolution), and a color space attribute of the content.

The attribute determination unit 104, in a case that a content attributes corresponding to the acquired device type and mode information has been already held, determines the held content attributes as content attributes to be provided to the device. For example, in a case that a content outputting apparatus with the same device type and the mode information as those of the content outputting apparatus currently being connected is newly discovered, the attribute determination unit 104 determines the content attributes already being held as newly discovered content attributes.

The attribute determination unit 104, in a case that a content attribute corresponding to the acquired device information and the mode information is not held, determines content attributes corresponding to the device type, by making an inquiry to the Web server 60. However, the attribute determination unit 104, in case that content information corresponding to the acquired device information and mode information is not held, may also determine the corresponding content attributes by causing the user to input it. The attribute determination unit 104 notifies the device information storage unit 107 of the determined content attributes and the MAC address of the discovered device.

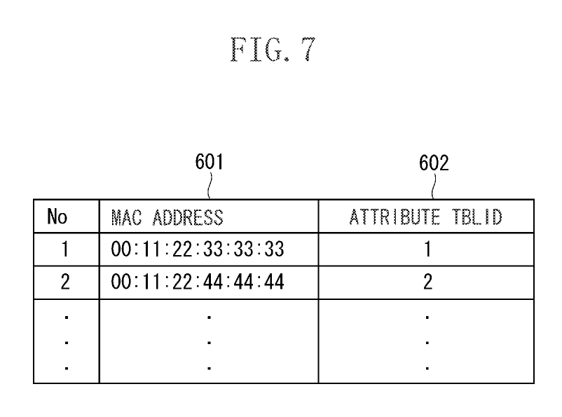

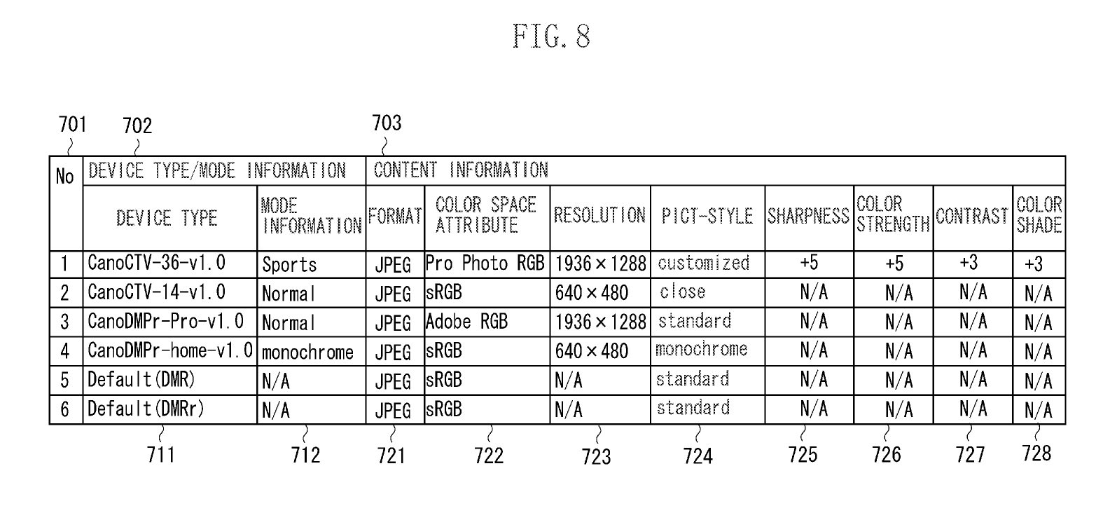

The device information storage unit 107 stores the MAC addresses and the content attributes in association with each other, notified from the attribute determination unit 104. The device information storage unit 107 according to the present exemplary embodiment stores the device information table illustrated in FIG. 7, and the attribute table illustrated in FIG. 8. In FIG. 7, MAC addresses 601 are MAC addresses of the content outputting apparatuses connected to the network 10. Attribute TBLIDs 602 correspond to numbers 701 of the attribute table illustrated in FIG. 8. The same number of the MAC addresses and the attribute TBLIDs as the number of the content outputting apparatuses judged to be connected to the network 10 are stored in FIG. 7.

In the attribute table in FIG. 8, default content attributes are included. When a heretofore discovered content outputting apparatus is disconnected, the attribute table may delete content attributes relating to the content outputting apparatus, or may hold the content attributes for a given period of time, even after the content outputting apparatus has been disconnected.

The content providing unit 103 receives a request (content acquisition request) from a device (content outputting apparatus) on the network 10. Then, the content providing unit 103 judges whether a MAC address of a transmission source of the received content acquisition request is registered in the device information table illustrated in FIG. 7. Then, if the transmission source MAC address is registered in the device information table, the content providing unit 103 acquires from the attribute table illustrated in FIG. 8 the content attributes of the content to be provided to the device that has transmitted the content acquisition request. Then, the content providing unit 103 makes a request of the content conversion unit 106 to process the content required from the content outputting apparatus, according to the content attributes acquired from the attribute table. Then, the content providing unit 103 provides the content processed by the content conversion unit 106, to the content outputting apparatus that transmitted the content acquisition request.

More specifically, the content providing unit 103, upon a receiving the content acquisition request from the content outputting apparatus as to which the content attributes (parameters) have been determined by the attribute determination unit 104, provides the content processed based on the determined content attributes. The attribute determination unit 104 determines the content attributes, based on the type information (device type) acquired by the device search unit 102.

The content conversion unit 106 converts a format, or a resolution (number of pixels), a development parameter, and a color space of the content, in accordance with a request of the content providing unit 103. The content conversion unit 106 performs thinning-out processing or interpolation processing of pixels of the content in a case of, for example, converting a number of pixels of the content to be provided.

The content management unit 105 is a module for managing contents that are saved in a storage (not illustrated) of the digital camera 20, and manages locations of the contents, or meta data of the contents. In this case, the contents to be managed are not only the contents saved in the storage of the digital camera 20, but also may be the contents saved in the Web server 60, through the Internet 50, for example.

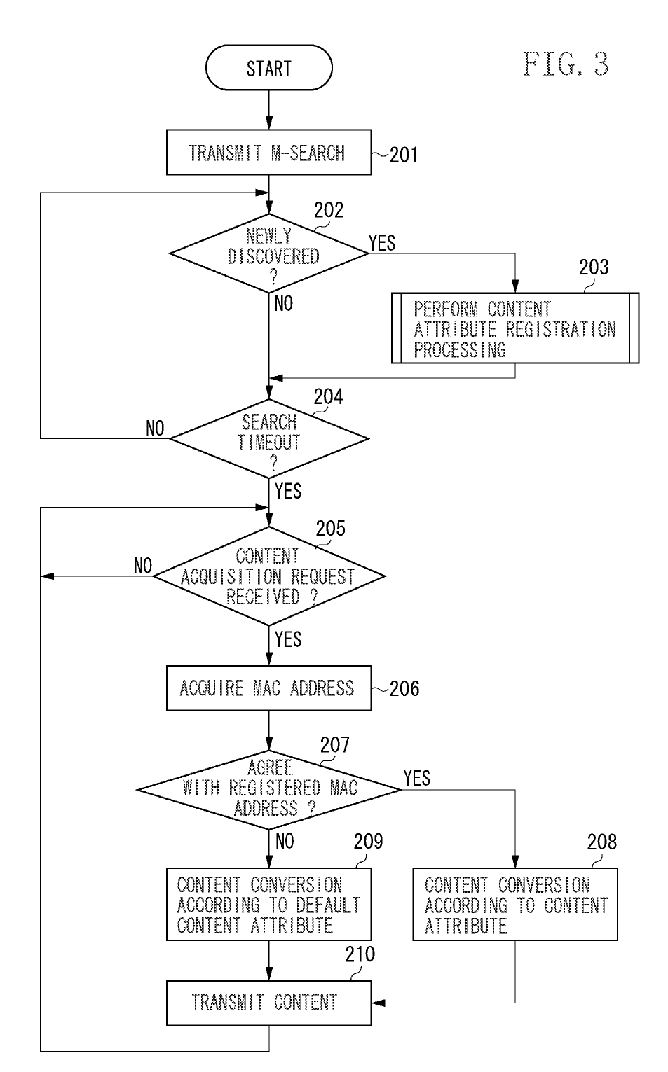

FIG. 3 is a flowchart illustrating processing of the digital camera 20. In step 201, the device search unit 102 searches for a content outputting apparatus connected to the network 10 using the M-Search request of the SSDP. More specifically, the device search unit 102 transmits search message for discovering a device connected to the network 10 in step 201.

In step 202, the device search unit 102 judges whether a new content outputting apparatus is discovered, based on a ubiquitous sensor network (USN) information (identification information) included in a response to the M-Search request. If it is judged that the new content outputting apparatus has been discovered (YES in step 202), the processing proceeds to step 203. If it is judged that the new content outputting apparatus has not been discovered (NO in step S202), the processing proceeds to step 204. It is also possible to judge whether the new content outputting apparatus has been discovered, based on not only the USN information but also the MAC address, for example.

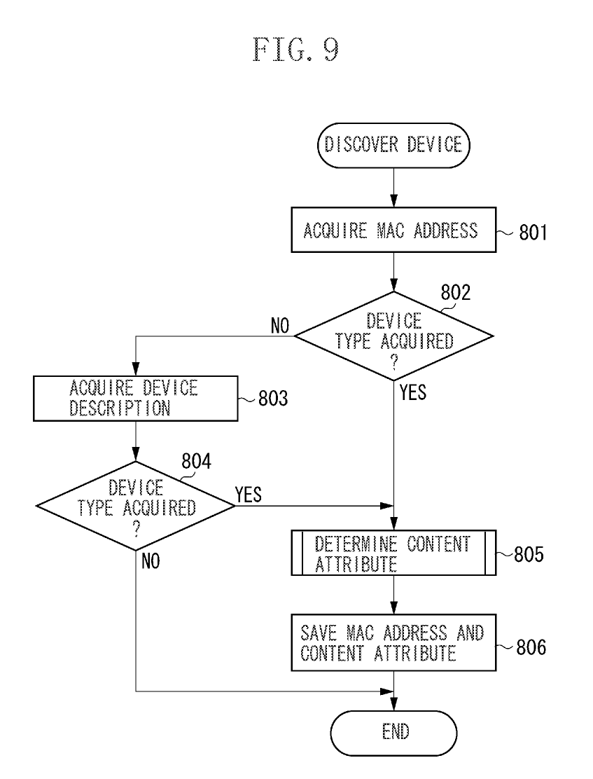

In step 203, the device search unit 102 acquires a device type of the content outputting apparatus newly discovered in step 202. Then, the attribute determination unit 104 determines content attributes suitable for the device type of the newly discovered content outputting apparatus. Then, the device information storage unit 107 stores the MAC address of the new content outputting apparatus, and the content attributes determined by the attribute determination unit 104 in association with each other. The details of the processing in step 203 will be described below with reference to FIG. 9.

In step 204, the device search unit 102 terminates search processing upon detecting a reception timeout of the response of the M-Search request (YES in step 204).

In step 205 (reception procedure), the content providing unit 103 waits for a content acquisition request from the content outputting apparatus connected to the network 10. If it is judged that the content providing unit 103 has received the content acquisition request in step 205 (YES in step S205), the processing proceeds to step 206. More specifically, the content providing unit 103 receives the request from the device (the content outputting apparatus) on the network 10 in step 205.

In step 206, the content providing unit 103 acquires a transmission source MAC address of the content acquisition request received in step 205, then the processing proceeds to step 207.

In step 207, the content providing unit 103 judges whether the MAC address acquired in step 206 is a MAC address registered in the device information table illustrated in FIG. 7. The device information table is stored in the device information storage unit 107. If it is judged that the MAC address acquired in step 206 is the MAC address registered in the device information table (YES in step S207), then the processing proceeds to step 208. If it is judged that the MAC address is not the registered MAC address (NO in step S207), then the processing proceeds to step 209.

In step 208, the content providing unit 103 requests the content conversion unit 106 to process the content requested from the content outputting apparatus, according to the content attributes suitable for the content outputting apparatus. More specifically, the content providing unit 103 acquires attribute TBLID corresponding to the MAC address acquired in step 206, from the device information table, and requests the content conversion unit 106 to process the content according to the content attributes corresponding to the acquired attribute TBLID.

The content attributes corresponding to the attribute TBLID is stored in the attribute table. FIG. 8 illustrates an example of the attribute table. The attribute table in FIG. 8 is composed of numbers 701, device type/mode information 702, and content attributes 703. The numbers 701 correspond to the attribute TBLIDs 602 in FIG. 7. The device type/mode information 702 includes device types 711 and mode information 712. The content attributes 703 are composed of content attributes such as, format information 721, color space attributes 722, and resolutions 723.

In step 208, the content conversion unit 106, in accordance with a request from the content providing unit 103, processes according to the content attributes the content requested from the content outputting apparatus.

For example, the attribute determination unit 104, if CanoDTV-36v1.0 is acquired as the device type of the DTV 30, determines a resolution of the content to be provided to the DTV 30 to be 1936×1288. In addition, the attribute determination unit 104, if CanoDTV-14v1.0 is acquired as the device type of the DPF 35, determines a resolution of the content to be provided to the DPF 35 to be 640×480. As described above, “36” of the device type of the DTV 30, and “14” of the device type of the DPF 35 indicate screen sizes, respectively.

More specifically, the device search unit 102 acquires type information (resolution 723) indicating a number of pixels of the content that the device plays back. Then, the attribute determination unit 104 determines a number of pixels that the device search unit 102 has acquired as a number of pixels of the content to be provided to the device. Then, the content providing unit 103 makes a request to the content conversion unit 106 that the requested content becomes a content having the number of pixels determined by the attribute determination unit 104, and provides the content that has been processed (thinning-out or interpolation processing of pixels) by the content conversion unit 106. By doing so, the content providing unit 103 can provide the content corresponding to the type information (number of pixels) of device that plays back the content.

In step 209, the content providing unit 103 makes a request to the content conversion unit 106 to convert the content requested from the content outputting apparatus, according to default content attributes stored in the device information storage unit 107. Then, in step 209, the content conversion unit 106 converts according to the default content attributes the content requested from the content outputting apparatus, in accordance with a request from the content providing unit 103. The default content attributes are number 5 (default content attribute of DMR), and number 6 (default content attribute of DMPr) in FIG. 8.

In step 210 (providing procedure), the content providing unit 103 provides the content converted by the content conversion unit 106 in step 208 or step 209 to the content outputting apparatus of transmission source of the content acquisition request received in step 205.

More specifically, in response to the content acquisition request from the content outputting apparatus, as to which the content attributes (parameters) have been determined by the attribute determination unit 104, the content providing unit 103 provides the content processed according to the determined content attributes. The attribute determination unit 104 determines the content attributes, based on the type information (device type) acquired by the device search unit 102.

Next, the details of the content attribute registration processing in step 203 in FIG. 3 will be described with reference to FIG. 9. FIG. 9 is a flowchart illustrating processing for registering in the device information table a content outputting apparatus which the digital camera 20 has discovered. As described above, the content attribute registration processing is performed depending on the judgment that a new device has been discovered in step 202 in FIG. 3.

In step 801, the device search unit 102 acquires a MAC address of a newly discovered device.

In step 802 (acquisition procedure), the device search unit 102 judges whether a device type and mode information are included in a response (200OK message) of the M-Search request. If it is judged that the device type and mode information are included in the 200OK message (YES in step 802), then the device search unit 102 acquires the device type and mode information, and the processing proceeds to step 805. If it is judged that the device type and mode information are not included (NO in step 802), then the processing proceeds to step 803.

More specifically, the device search unit 102 transmits a search message (M-Search request) for discovering a device connected to the network 10. Then, if type information is included in a reply from the device to the search message, the device search unit 102 acquires the type information in step 802.

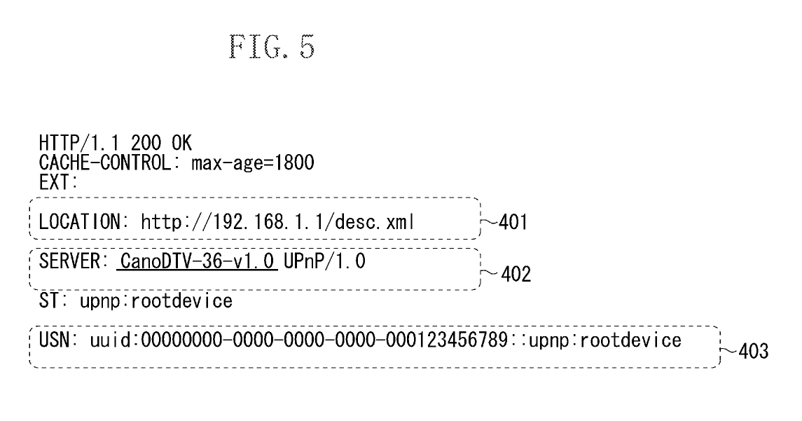

An example of response M-Search request is illustrated in FIG. 5. The device search unit 102 according to the present exemplary embodiment judges that the device type and the mode information are not included in a response illustrated in FIG. 5. As a result, the device search unit 102 does not acquire the type information, and the processing proceeds to step 803.

In step 803, the device search unit 102 transmits HTTP GET request to obtain the device description, using a location 401 included in a response of the M-Search request as a destination. Then, the device search unit 102 acquires a device description as a response of the HTTP GET request.

In step 804 (acquisition procedure), the device search unit 102 judges whether the device type and mode information are included in the device description acquired in step 803. The device search unit 102, when it is judged that the device type and mode information are included in the device description (YES in step 804), acquires them, then the processing proceeds to step 805. When it is judged that the device type and mode information are not included (NO in step 804), the device search unit 102 terminates the processing in FIG. 9.

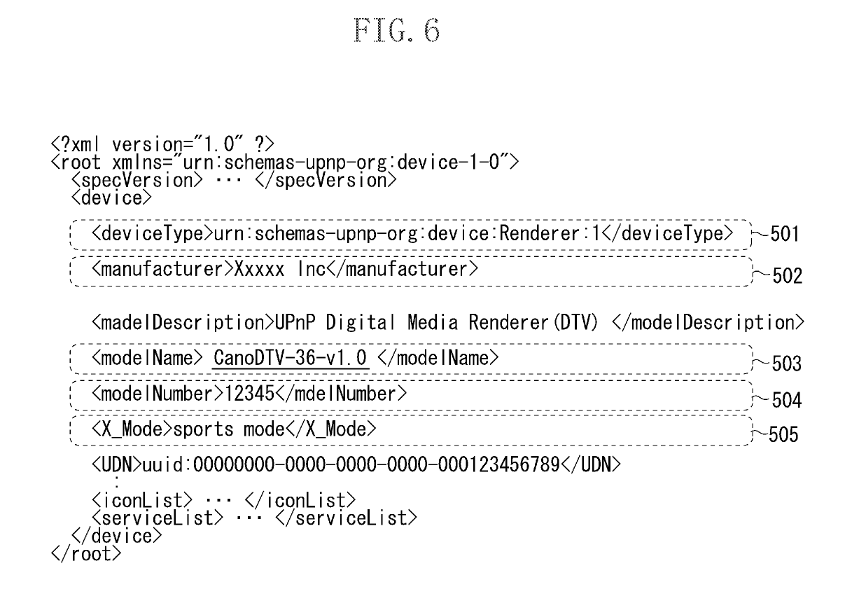

FIG. 6 illustrates an example of the device description acquired in step 803. The device description according to the present exemplary embodiment includes a device type 501, a manufacturer information 502 of the device, a model name (device type) 503 of the device, a model number 504, and mode information 505. The model name 503 in FIG. 6 includes a product name (CanoDTV) of the device, a screen size (36 inch), a version (v1.0). The mode information 505 in FIG. 6 indicates that newly discovered content outputting apparatus is in sports mode.

In step 804, the device search unit 102 according to the present exemplary embodiment, upon receiving the device description like FIG. 6 in step 803, acquires the model name 503 of the device as the device type, and acquires the mode information 505 as the mode information, then the processing proceeds to step 805. More specifically, in step 803, the device search unit 102 transmits a request message (HTTP GET request) for requesting type information, to the device that has made a reply to the search message (M-Search message). Then, in step 804, the device search unit 102 acquires the type information included in the reply to the request message (HTTP GET request) from the device, which is transmitted in step 803.

In step 805 (determination procedure), the attribute determination unit 104 determines the content attributes corresponding to the device type and mode information acquired by the device search unit 102 in steps 802, or 804. Alternatively, the attribute determination unit 104 may acquire device type and mode information piece by piece in steps 802 and 804, and may determine the content attributes. More specifically, instep 805, the attribute determination unit 104 determines parameters (content attributes) of the content to be provided to the device corresponding to the device type, based on the device type acquired by the device search unit 102.

In step 806, the device information storage unit 107 stores the MAC address acquired in step 801, and the content attributes determined in step 805 in association with each other, and terminates the content attribute registration processing in FIG. 9. As described above, the content providing apparatus (the digital camera 20) according to the present exemplary embodiment determines the content attributes corresponding to a newly discovered content outputting apparatus. Then, when a content acquisition request is received from the content outputting apparatus after the content attribute determination, the content providing apparatus provides the content processed according to the determined content attributes. With a method for processing the contents by such content providing apparatus, a time required from receiving the request for the content until starting to provide the content of the content attributes corresponding to the type of the device that requested the content, can be shortened.

The device search unit 102 according to the present exemplary embodiment acquires the device type and mode information, in response to an advertise (alive) message of the SSDP from the content outputting apparatus. More specifically, the device search unit 102 according to the present exemplary embodiment judges whether parameters of the content to be provided to the device that has transmitted alive message (live status confirmation message) are determined by the attribute determination unit 104. Then, if it is judged that the parameters are not determined by the attribute determination unit 104, then the device search unit 102 transmits the request message (HTTP GET request) for obtaining the type information, to the device that has transmitted the alive confirmation message. The device search unit 102 acquires type information included in a reply (device description) to the request message from the content outputting device.

By doing so, it becomes possible for the device search unit 102 to acquire the device type and mode information of a newly connected content outputting apparatus, earlier than in a case of using only the M-Search.

The device search unit 102 according to the present exemplary embodiment performs search by the M-Search at every predetermined time also in step 205 and the subsequent steps in FIG. 3, and acquires the device type and mode information of a newly connected content outputting apparatus. Further, the device search unit 102, based on a reply to the M-Search request transmitted at every predetermined time, detects change of the mode information of the device already connected to the network 10. Then, the device search unit 102 changes the content attributes of the device which has changed the mode information.

More specifically, the device search unit 102, based on type information of one device (DTV 30) and information concerning a playback mode, determines parameters (content attributes) of the content which the attribute determination unit 104 provides to the DTV 30, and subsequently acquires information concerning the playback mode from the DIV 30. Then, the attribute determination unit 104, if there is a difference between the playback mode of the DTV 30 when the content attributes are determined, and the playback mode of the DTV 30 acquired after the content attributes have been determined, changes the parameters of the content to be provided to the DTV 30.

As an example, a case that the playback mode of the DTV 30 stored, for example, on a first line on the attribute table in FIG. 8 is changed from a normal mode to a sports mode, will be described. In this process, the sports mode is a playback mode for playing back videos with higher sharpness than when the normal mode is set. When the device search unit 102 detects that the playback mode of the DTV 30 is changed from the normal mode to the sports mode, the attribute determination unit 104 changes the content attributes corresponding to the DTV 30, so that a sharpness of video to be provided is enhanced.

By doing so, the attribute determination unit 104, if the mode information of the content outputting apparatus is changed, can determine the content attributes corresponding to the mode information after the change. However, if the content attributes are determined without using the mode information or the like, the attribute determination unit 104 may be configured not to detect a change of the mode information.

The device search unit 102 judges whether the content outputting apparatus is disconnected from the network 10, according to the advertise (BYEBYE) message of the SSDP, or a timeout of an alive period of time or the like. Then, the device search unit 102, if it is judged that the content outputting apparatus has been disconnected from the network 10, deletes the MAC address and the content attributes of the disconnected content outputting apparatus from the device information storage unit 107.

More specifically, the device search unit 102 judges whether a device corresponding to the identification information (MAC address) stored in the device information storage unit 107 is disconnected from the network 10. Then, the device search unit 102 deletes from the device information storage unit 107 the information (the content attributes) of parameters of the content to be provided to the device judged to have been disconnected from the network 10. By doing so, a memory amount necessary for the device information storage unit 107 can be reduced. However, the state may be made inactive instead of deleting the information of the parameters to be provided to the device judged to have been disconnected from the network 10.

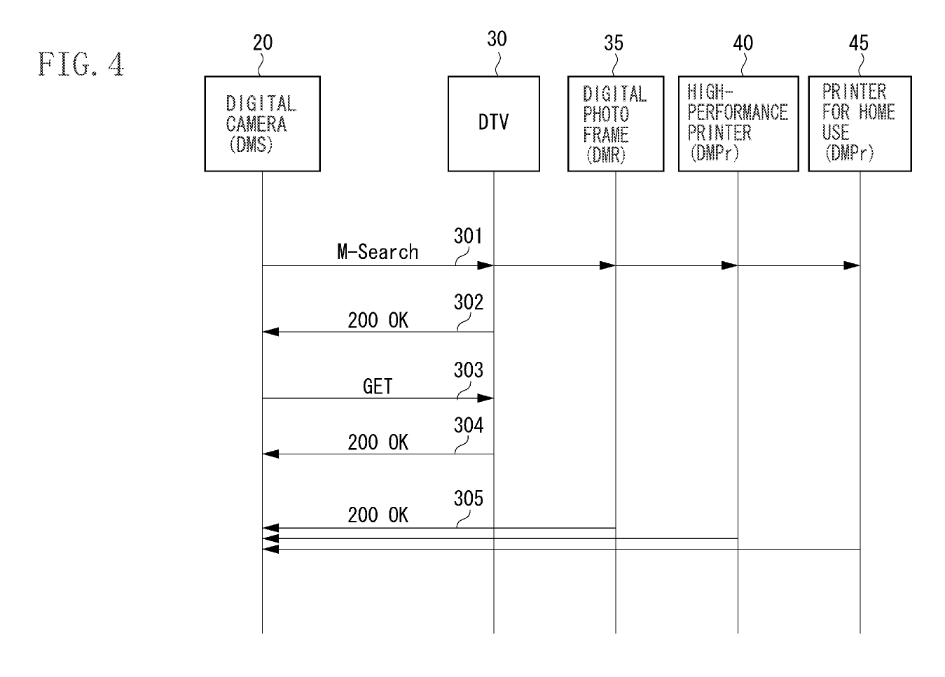

Next, processing performed by the digital camera 20 according to the present exemplary embodiment will be described with reference to the sequence diagram in FIG. 4.

In step 301 in FIG. 4, the digital camera 20 transmits the M-Search request by multi-cast to the network 10.

In step 302, the digital camera 20 receives a response (200OK message) of the M-Search request from the DTV 30. An example of a response of the M-Search request is as illustrated in FIG. 5.

In step 303, the digital camera 20 transmits an acquisition request (HTTP GET request) of the device description to a location 401 in FIG. 5. In step 304, the digital camera 20 receives 200OK response including the device description, from the DTV 30, as a response to the HTTP GET request. An example of the device description of the DTV 30 that the digital camera 20 receives in step 304 is as illustrated in FIG. 6.

The attribute determination unit 104 of the digital camera 20 that has thus received the device description of the DTV 30 determines content attributes (parameters) suitable for the DTV 30. Then, when the content acquisition request is received from the device (DTV 30) of which parameters are determined by the attribute determination unit 104, the content providing unit 103 provides the content that has been processed based on determined parameters. The digital camera 20, similarly to an example of the DTV 30, receives a response to the M-Search request, and a response to the HTTP GET request even from the DPF 35, the high-performance printer 40, and the home printer 45.

With the digital camera 20 (the content providing apparatus) according to the present exemplary embodiment, a time required from receiving the content acquisition request from the content outputting apparatus until starting to prove the content suitable for the device type of the content outputting apparatus that has requested the content, can be shortened.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-201478 filed Sep. 1, 2009, which is hereby incorporated by reference herein in its entirety.

What is claimed is:

1. A content providing apparatus that provides contents in accordance with a request from a device on a network comprising:
an acquisition unit configured to acquire type information of the device on the network;
a determination unit configured to determine parameters of content to be provided to the device corresponding to the type information, based on the type information acquired by the acquisition unit;
a reception unit configured to receive a request from the device on the network; and
a providing unit configured to provide to the device that transmitted the request, content processed based on parameters determined by the determination unit, in response to the request from the device on the network whose parameters are determined by the determination unit based on the type information acquired by the acquisition unit.

2. The apparatus according to claim 1, wherein the acquisition unit acquires type information indicating a number of pixels of the content that the device plays back, and
wherein the determination unit determines a number of pixels of the content to be provided to the device, to be the number of pixels that the acquisition unit has acquired.

3. The apparatus according to claim 1, wherein the acquisition unit further comprises:
a transmission unit configured to transmit a search message for discovering a device to be connected to the network,
wherein the acquisition unit acquires type information included in a reply to the search message from the device to be connected to the network.

4. The apparatus according to claim 1, wherein the acquisition unit further comprises:
a transmission unit configured to transmit a search message for discovering a device to be connected to the network, and transmit a request message to obtain type information to the device to be connected to the network that has made a reply to the search message,
wherein the acquisition unit acquires the type information included in the reply to the request message from the device.

5. The apparatus according to claim 1, wherein the reception unit receives alive message from the device connected to a network, and the acquisition unit further comprises:
a judgment unit configured to judge whether parameters of a content to be provided to the device that transmitted the alive message are determined by the determination unit, and
a transmission unit configured to, if it is judged by the judgment unit that parameters of the content to be provided to the device that transmitted the alive confirmation message are not determined by the determination unit, transmit a request message to obtain type information to the device that has transmitted the alive confirmation message,
wherein the acquisition unit acquires type information included in a reply to the request message from the device.

6. The apparatus according to claim 1,
wherein the acquisition unit acquires the type information, as well as information concerning a playback mode, and
wherein the determination unit determines parameters of the content to be provided to the device based on information concerning the acquired type information and playback mode.

7. The apparatus according to claim 6,
wherein after the determination unit has determined parameters of the content to be provided to the device based on information concerning the acquired type information and playback mode, the acquisition unit acquires information of the playback mode from the device, and
wherein if the playback mode of the device when parameters of the content are determined is different from the playback mode of the device acquired after parameters of the content have been determined, the determination unit changes the parameters of the content to be provided to the device.

8. The apparatus according to claim 1, further comprising:
a storage unit configured to store parameters determined by the determination unit, and identification information of the device;
a judgment unit configured to judge whether the device corresponding to identification information stored by the storage unit is disconnected from the network; and
a deletion unit configured to delete from the storage unit information of parameters of the content to be provided to the device judged by the judgment unit to have been disconnected from the network.

9. A content processing method performed by a content providing apparatus that provides contents in accordance with a request from a device on a network, the method comprising:
acquiring type information of the device on the network;
determining, based on the acquired type information, parameters of content to be provided to the device corresponding to the type information;
receiving a request from the device on the network; and
in response to the request from the device on the network, whose parameters have been determined based on the acquired type information, providing the content processed based on the determined parameters to the one device.

10. A computer-readable storage medium storing a program that causes a computer to implement a content processing method, the method comprising:
acquiring type information of the device on the network;
determining parameters of content to be provided to the device corresponding to the type information, based on the acquired type information;
receiving a request from the device on the network; and
in response to the request from the device on the network, whose parameters have been determined based on the acquired type information, providing the content processed based on the determined parameters to the device that has transmitted the request.
